(19) United States
(12) Patent Application Publication
(10) Pub. No.: US 2014/0189780 A1
(43) Pub. Date: Jul. 3, 2014

(54) Method and Apparatus for Limiting Digital Content Distribution Inside Defined Real-world Geographic Area(s)

(71) Applicant: Haixiang He, Foster City, CA (US)

(72) Inventor: Haixiang He, Foster City, CA (US)

(21) Appl. No.: 13/730,952

(22) Filed: Dec. 29, 2012

(51) Int. Cl. G06F 21/60

(52) U.S. Cl. CPC G06F 21/60
USPC 726/1

(57) ABSTRACT

A method for limiting digital content distribution inside defined real-world geographic area(s) is disclosed. In one embodiment, the method is realized by adding additional distribution policy for geographical control to digital content's metadata, requesting the receiver to acquire and provide its current location, checking receiver's current location against the geographic control distribution policy, and distributing the content if the distribution policy is satisfied.

### CROSS-REFERENCE TO RELATED APPLICATIONS

This patent application claims priority to U.S. Provisional Patent Application No. 61/582129, entitled “Method and Apparatus for Limiting Digital Content Distribution Inside Defined Real-world Geographic Area(s)”, filed on Dec. 30, 2011 and naming Haixiang He as inventor, the disclosure of which is hereby incorporated herein, in its entirety, by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention is in the technical field of digital content distribution. More particularly, the present invention is in the technical field of limiting digital content distribution inside defined real-world geographic area(s).

### BACKGROUND OF THE INVENTION

The present invention is in the technical field of digital content distribution. More particularly, the present invention is in the technical field of limiting digital content distribution inside defined real-world geographic area(s).

Digital content distribution is the principle of providing digital information and content over the Internet in the form of products or services. Common examples of digital content distribution include music, video games, films, books, and software.

Technologies including Digital Right Management (DRM) have been developed to enable distributors to control their digital content distribution. Most existing technologies focus on preventing unauthorized redistribution since piracy of digital content has a far greater impact than it does for traditional media due to the direct nature and lower prices of online distribution as well as due to the easiness of duplicating digital content.

Currently there is no efficient or easy way to control the digital content distribution inside defined real-world geographic area(s), while on the other hand physical content distribution can be easily controlled inside defined real-world geographic area(s). For example, a specific print book can only be sold at a particular physical bookstore. But currently it is quite difficult for an eBook to be sold only at the same particular physical bookstore.

Due to the nature of Internet, digital content can be distributed anywhere in the world and a consumer can receive the digital content anywhere in the world. However, there are many use cases and motivations to control digital content distribution inside defined real-world geographic area(s) and a consumer can only receive the digital content when he or she is inside defined real-world geographic area(s). And hence, such a control method and apparatus is desired.

### SUMMARY OF THE INVENTION

The present invention is a method and apparatus to control the digital content distribution. It enables the digital content to be distributed to receivers who, during the distribution process, are inside certain defined real-world geographic area(s).

These geographic areas can be a predefined set of boundaries like coffee shops, bookstores, school attendance zones or neighborhood boundaries. They can also be dynamically generated as in a radius around a store or point location and/or as in any customized shape.

Information representing the defined real-world geographic area(s) is associated with each piece of digital content. The association can be achieved for example by adding the information to the digital content's metadata.

The digital content receiver must have the capability to acquire its current location. The current location may be in the format of a pair of data (latitude, longitude). The location can be acquired through Global Position System (GPS) or other location acquisition systems and services. During the digital content distribution process, the receiver needs to provide its current location to the digital content distribution system.

Function or capability to limit digital content distribution inside defined real-world geographic area(s) can be added to the digital content distribution system. During the distribution process, the system needs to ask the receiver to provide its current location. If the receiver fails to provide its current location, or the receiver's current location is outside the defined real-world geographic area(s), the system will not distribute the digital content. Otherwise, the system will continue the distribution process and eventually distribute the digital content to the receiver if all conditions are satisfied.

Those skilled in the art will appreciate the scope of the present invention and realize additional aspects thereof after reading the following detailed description of the preferred embodiments in association with the accompanying figures.

### BRIEF DESCRIPTION OF THE DRAWINGS

The present invention is illustrated by way of example in the following drawings in which like references indicated similar elements. The following drawings disclose various embodiments of the present invention for purposes of illustration only and are not intended to limit the scope of the invention. For purposes of clarity, not every component may be labeled in very figure. In the figures:

FIG. 1 is a system for distributing digital content over the Internet according to an embodiment of the present invention;

FIG. 2 is a functional block diagram of a digital content receiver according to an embodiment of the present invention;

FIG. 3 is a functional block diagram of a digital content distribution server according to an embodiment of the present invention;

FIG. 4 is a functional block diagram of a digital content database according to an embodiment of the present invention;

FIG. 5 shows a real-world geographic area dynamically generated as in a radius around a location point according to an embodiment of the present invention;

FIG. 6 shows a real-world geographic area dynamically generated as in a polygon according to an embodiment of the present invention; and

FIG. 7 is a flow diagram of a process of distributing a piece of digital content according to an embodiment of the present invention.

### DETAILED DESCRIPTION OF THE INVENTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

FIG. 1 illustrates a digital content distribution system 100. In FIG. 1, digital content receiver 110 is requesting digital content from digital content distribution server 120. Digital content receiver and digital content distribution server are connected through but not limited to Internet including mobile Internet. Digital content database 130 stores all information related to each piece of digital content. It may connect with digital content distribution server directly or through Internet. It may also co-locate with or be part of the digital content distribution server.

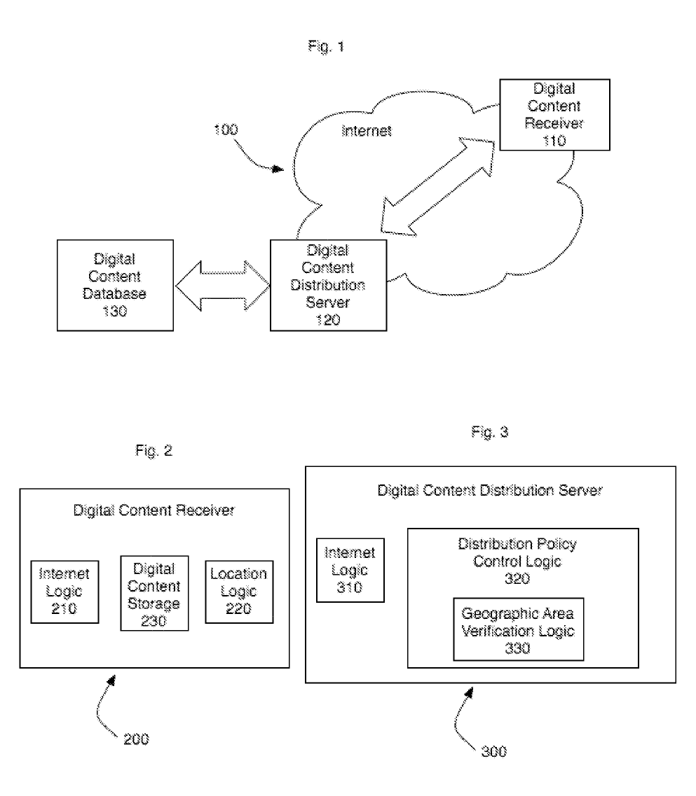

FIG. 2 is a functional block diagram showing the relevant components of an example digital content receiver 110 that may be used to receive digital content. Digital content receiver can be any hardware or software that is capable of receiving digital content. In the embodiment shown in FIG. 2, the digital content receiver 200 includes an Internet logic 210 configured to enable the digital content receiver to communicate with digital content distribution server through Internet especially mobile Internet. Digital content receiver 200 also includes location logic 220 configured to enable the digital content receiver to acquire its current location in latitude and longitude format. Digital content receiver 200 may also contain digital content storage 230 configured to store digital content. Digital content receiver 200 may also contain other components.

FIG. 3 is a functional block diagram showing the relevant components of an example digital content distribution server 120 that may be used to distribute digital content. Digital content distribution server can be any hardware or software that is capable of distributing digital content. In the embodiment shown in FIG. 3, the digital content distribution server 300 includes an Internet logic 310 configured to enable the digital content distribution server to communicate with digital content receiver and digital content database through Internet especially mobile Internet. Digital content distribution server 300 also includes distribution policy control logic 320 configured to enable the digital content distribution server to enforce the distribution policy for digital content. Distribution policy control logic 320 includes geographic area verification logic 330 configured to enable the digital content distribution server to limit the digital content distribution to defined real-world geographic area(s). Digital content distribution server 300 may also contain other components.

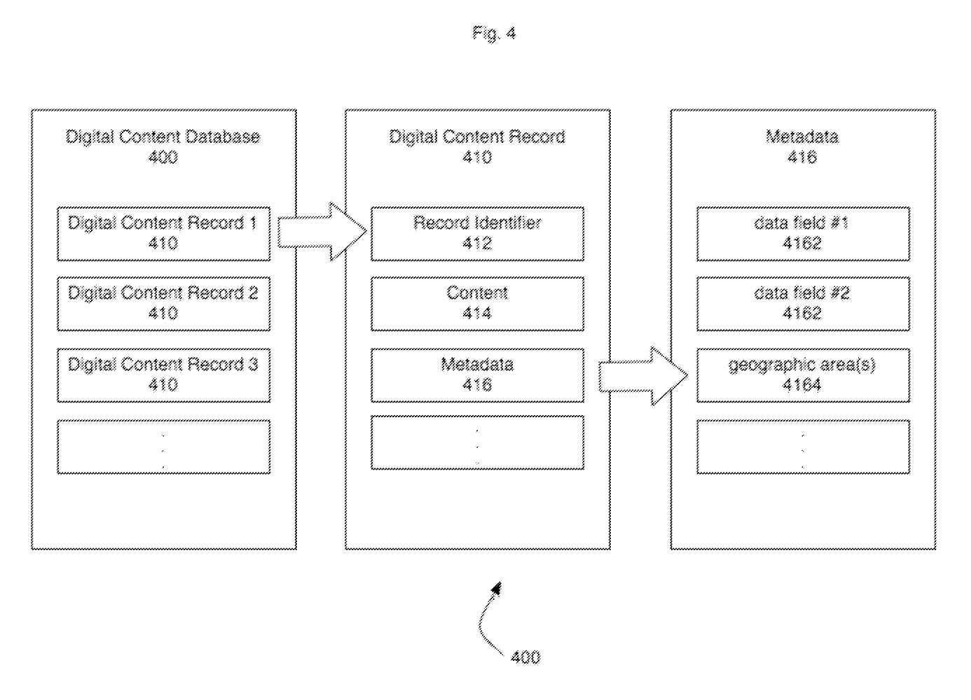

FIG. 4 is a functional block diagram showing the relevant components of an example digital content database 130 that may be used to store digital content. Digital content database can be any hardware or software that is capable of storing digital content. In the embodiment shown in FIG. 4, the digital content database 400 includes a number of digital content records 410 configured to store each piece of digital content. Digital content record 410 includes record identifier 412 configured to uniquely identify each piece of digital content, content 414 configured to store the real content part of the digital content record 410, and metadata 416 configured to store information related to the digital content. Digital content record 410 may also contain other fields. Metadata 416 includes a number of data fields 4162 configured to store metadata information related to the corresponding digital content. One data field 4162 is geographic area(s) 4164 configured to store defined real-world geographic area(s). Digital content can be any type of digital content including digital music, digital video, eBook, etc., according to an embodiment of the present invention.

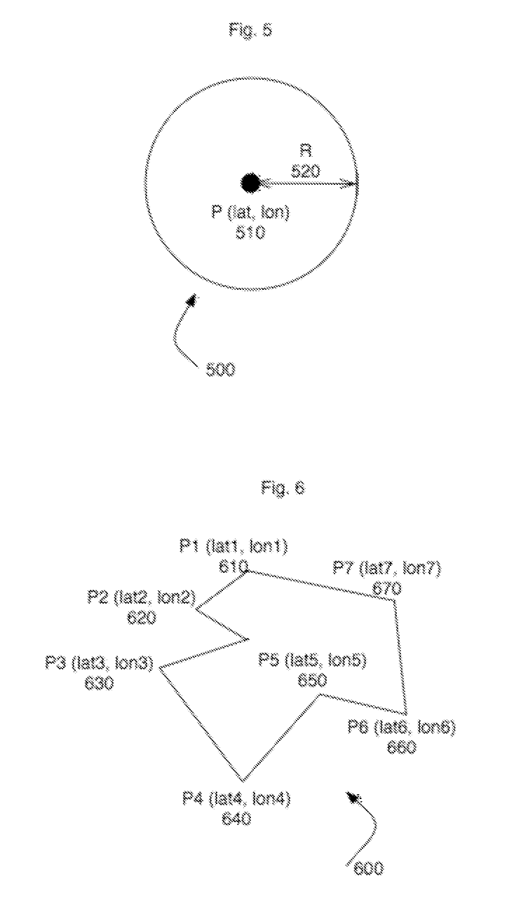

FIG. 5 shows a geographic area dynamically generated as in a radius around a location point according to an embodiment of the present invention. In the embodiment shown in FIG. 5, the geographic area(s) 500 is dynamically generated as in a radius R 520 around a location point P 510. Location point P 510 represents a real-world location point with latitude lat and longitude lon.

FIG. 6 shows a geographic area dynamically generated as in a polygon according to an embodiment of the present invention. In the embodiment shown in FIG. 6, the geographic area 600 is dynamically generated as in a polygon. The polygon is specified by locations points P1 610 representing a real-world location point with latitude lat1 and longitude lon1; P2 620 representing a real-world location point with latitude lat2 and longitude lon2; P3 630 representing a real-world location point with latitude lat3 and longitude lon3; P4 640 representing a real-world location point with latitude lat4 and longitude lon4; P5 650 representing a real-world location point with latitude lat5 and longitude lon5; P6 660 representing a real-world location point with latitude lat6 and longitude lon6; and P7 670 representing a real-world location point with latitude lat7 and longitude lon7.

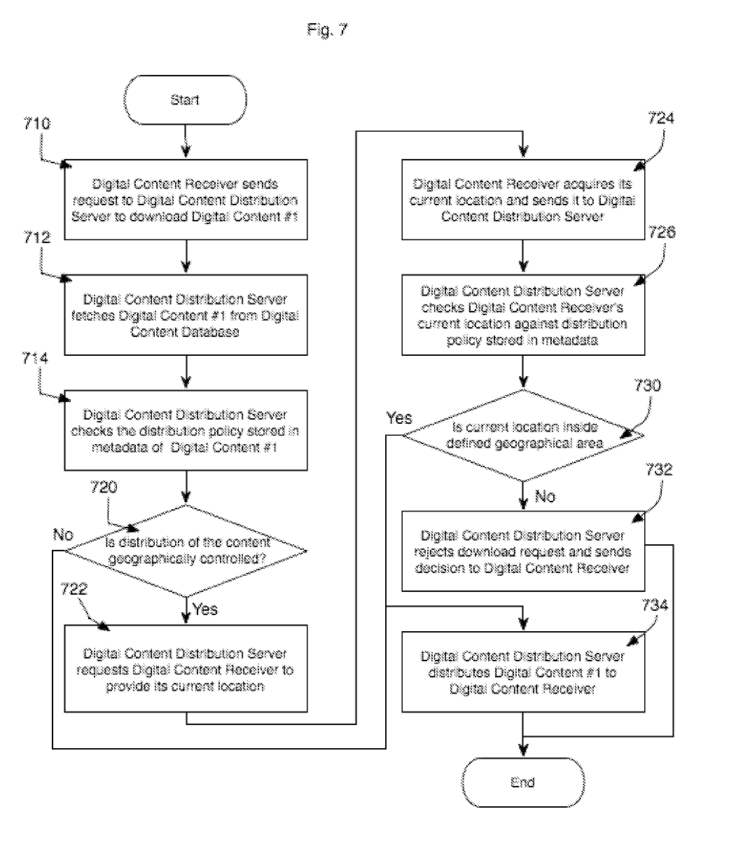

FIG. 7 is a flow diagram of a process for distributing a piece of digital content with distribution policy to control the distribution inside defined real-world geographic area(s) according to an embodiment of the invention. While particular messages may be described in connection with FIG. 7, the invention is not limited to this particular sequence of message as other sequences may be used as well. Also, the messages in the following description have been given particular names for ease of reference. The names of the messages may change without departing from the scope of the invention.

As shown in FIG. 7, when a digital content receiver wants to download a piece of digital content, it may send a download request to digital content distribution server (710). The download request may contain the digital content identifier (digital content #1) indicating the exact piece of digital content for downloading.

Upon receipt of a download request, the digital content distribution server will send fetch digital content record request to digital content database. The digital content record is identified by the digital content identifier (digital content #1). Upon receipt of a fetch digital record request, the digital content database will send the corresponding digital content record to digital content distribution server (712).

The digital content distribution server, upon receipt of the digital content record, will extract the metadata inside the digital content record (714). If the metadata does not contain the policy to control the content distribution geographically (720), then the digital content distribution server will distribute the digital content to digital content receiver (734). Otherwise (720), the digital content distribution server will send a location request to digital content receiver to provide its current location (722).

Upon receipt of a location request from digital content distribution server, the digital content receiver will acquire its current location and send it to digital content distribution server (724). In one embodiment of the invention, the current location is a latitude and longitude pair. Upon receipt of digital content receiver's current location, the digital content distribution server will check it against distribution policy stored in metadata especially the defined real-world geographical area(s) (726).

If the digital content receiver's current location is not inside the defined geographical area(s) (730), the digital content distribution server will reject digital content receiver's download request and send reject notification to digital content receiver (732). Otherwise (730), the digital content distribution server will distribute the digital content to digital content receiver (734).

It should be understood that all functional statements made herein describing the functions to be performed by the methods of the invention may be performed by software programs implemented utilizing subroutines and other programming techniques known to those of ordinary skill in the art. Alternatively, these functions may be implemented in hardware, firmware, or a combination of hardware, software, and firmware. The invention is thus not limited to a particular implementation.

The control logic in this embodiment may be implemented as a set of program instructions that are stored in a computer readable memory within the network element and executed on a microprocessor on the network element. However, in this embodiment as with the previous embodiments, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. All such embodiments are intended to fall within the scope of the present invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A method of limiting digital content distribution inside defined real-world geographic areas, the method comprising the steps of:
associating a content distribution control policy with a content record;
acquiring a current location of a content distribution device; and
determining a distribution of the content record based on the content distribution control policy and the current location of the content distribution device for distributing the content record on the content distribution device.

2. The method as claimed in claim 1, wherein the distribution control policy has one or a plurality of the real-world geographic areas.

3. The method as claimed in claim 2, wherein the real-world geographic area is defined at least as one of the specifications as a pre-defined boundary for a point of interest, a radius around a point of interest, and a customized polygon shape around a point of interest.

4. The method as claimed in claim 1, further comprising sending the content record having the control policy for controlling a distribution of the content record on the content distribution device.

5. The method as claimed in claim 1, wherein the current location is acquired through one or a plurality of methods of using Global Position System (GPS) or other location acquisition systems and services.

6. The method as claimed in claim 5, further comprising specifying the current location in a pair of data (latitude, longitude) format

7. The method as claimed in claim 1, wherein determining the distribution of the content record comprises checking the current location of the content distribution device against the content distribution control policy based on the defined real-world geographic areas.

8. The method as claimed in claim 7, further comprising allowing the distribution of the content record based on the current location being inside the defined real-world geographic areas.

9. The method as claimed in claim 7, further comprising prohibiting the distribution of the content record based on the current location being outside the defined real-world geographic areas.

10. A system for limiting digital content distribution inside defined real-world geographic areas comprising:
a storage system for storing a content record;
a content management logic for associating a content distribution control policy with the content record;
a communication logic for sending the content record having the control policy;
a location logic for acquiring a current location of a content distribution device; and
a distribution control logic for determining a distribution of the content record on the content distribution device.

11. The system as claimed in claim 10, wherein the content distribution control policy is specified as one or a plurality of the real-world geographic areas.

12. The system as claimed in claim 11, wherein the real-world geographic areas are defined at least as one of the descriptions as a pre-defined boundary for a point of interest, a radius around a point of interest, and a customized polygon shape around a point of interest.

13. The system as claimed in claim 10, wherein the distribution control logic includes a geographic control logic that checks the current location of the content distribution device against the content distribution control policy.

14. The system as claimed in claim 13, wherein the geographic control logic determines allowing the distribution of the content record based on the current location being inside the geographic area.

15. The system as claimed in claim 13, wherein the geographic control logic determines prohibiting the distribution of the content record based on the current location being outside the geographic area.
